(19) United States
(12) Patent Application Publication
(10) Pub. No.: US 2007/0184847 A1
(43) Pub. Date: Aug. 9, 2007

(54) Method and a system for safe pairing of wireless communication devices

(75) Inventors: Per Hvid Hansen, Lynge (DK); Per Einar Pontus Holm, Tygelsjo (SE); Morten Stribek, Frederiksberg (DK)

Correspondence Address: NOVO NORDISK, INC.;PATENT DEPARTMENT, 100 COLLEGE ROAD WEST, PRINCETON, NJ, 08540, US

(73) Assignee: Novo Nordisk A/S, Bagsvaerd (DK)

(21) Appl. No.: 11/508,355

(22) Filed: Aug. 23, 2006

Related U.S. Application Data
(63) Continuation of application No. PCT/DK05/00023, filed on Jan. 17, 2005.

(30) Foreign Application Priority Data
Feb. 26, 2004 (DK) PA 2004 00307

(51) Int. Cl. H04Q 7/20

(52) U.S. Cl. 455/456.1

(57) ABSTRACT

The present invention relates to a method and a system for safe pairing of wireless communication medical devices in a situation when multiple servers are within the reach of a client by determining and indicating the number of wireless medical devices responding to a node query broadcast and accordingly establishing a connection with the appropriate medical device.

### CROSS-REFERENCE TO RELATED APPLICATIONS

This application is a continuation of International Application No. PCT/DK2005/000023 filed Jan. 17, 2005, which claims priority from Danish Patent Application No. PA 2004 00307 filed Feb. 26, 2004 and to U.S. Patent Application No. 60/551,306 filed Mar. 8, 2004.

### FIELD OF THE INVENTION

The present invention relates to the field of wireless communication. More specifically, it relates to a method and a system for safe pairing of wireless medical devices in a situation when multiple servers are within the reach of a client.

### BACKGROUND OF THE INVENTION

Rapid developments in the field of communication require frequent updates of communication soft-, hard- and or firmware in a medical device.

Also, advances in microprocessor and communication technology have led to the increase in popularity of wireless communication. Today, various efforts are under way to apply wireless communication to replace attachment cables used for attaching peripheral devices as well as networking cables.

Therefore, for any two parties to effectively communicate over a network (including humans, computers etc.) a certain protocol has to be followed also known as the communication protocol. A protocol may be defined as a definite set of rules, conventions and data structures that governs how computers exchange information over a network. In other words, a protocol can be defined as a standard procedure, which enables two or more data communication devices to accept and use to exchange data.

In the field of computer and telecommunication, the interaction between two entities occurs at various levels of abstraction and varied functionality. These levels are called the layers of the networking protocol and the combined set of protocol between each pair of communicating layers is called a protocol stack.

A wide variety of communication protocols exist which have been defined and accepted by many standard organizations. One of the most widely accepted and popular protocols is TCP/IP that is considered as the heart of internetworking communications.

Another leading candidate to wireless networking is commonly known to those skilled in the art as the Bluetooth technology or Bluetooth protocol. Examples of technology are known to those skilled in the art and include different variants of IEEE 802.11 Standard published by the Institute of Electrical and Electronic Engineers

However it has now become desirable for devices to be able to operate “concurrently” in multiple wireless protocols for numerous applications one such application being in area of medical applications.

Medical product and software validation is required for a medical device with updated communication means even though no changes have been made to the medical application “part” of the device.

Such devices are available for the treatment of various diseases such as diabetes, for measuring blood sugar for withdrawing blood samples the purpose of which is to enable the user to nurse his disease discretely with a high standard of safety.

WO99/35588 describes a method for monitoring the compliance of a prescribed treatment regime by the patient, according to which the workstation transmits dosage data to a dispensing device via a communication link.

International publication number WO 03/005891 relates to a method and system for automatically transmitting data between two portable medical devices which includes checking for unique and individual apparatus identification number for each apparatus and then pairing the apparatuses. The step of automatically transmitting data information between two portable devices includes one or more the following:
checking the unique and individual apparatus identification number of each client/server and
pairing the client with the server by linking with their unique identification number

Thus communication between the two apparatuses is established only once the identification is in the affirmative.

International publication number, WO 03/015838 relates to portable medial devices and method for communicating of data information. The protocol is designed to operate in noisy frequency environments which uses a fast acknowledgement and frequency hopping scheme to make the link robust. It hops to a new frequency after transmitting or receiving a packet, the packet containing the destination address. As illustrated by FIG. 1, the communication between the medical part (101) and the communication part (102) is established by the well-known Bluetooth protocol. The details of the schematic block diagram are as disclosed in International publication no WO03/015838 which reference is incorporated herein.

International publication number, WO 01/24690 claims a medicament delivery system consisting of network computer system to enable communication of data between the network computer system and an electronic data management system. This uses a file transfer protocol. The system according to this invention ensures data transfer with a network of computers, which network can be further networked for cross-transfer of data.

U.S. Pat. No. 5,363,842 also relates to a medical device in particular an inhalation device wherein the device enables the data relating to the patient to be collected, analyzed and displayed to the patient. This data is then stored in a memory for download to a workstation at the clinic.

In the above-mentioned inventions, the process of authentication of servers uses their addresses and digital certificates. In case there is heavy network traffic and an unintended server responds, safe pairing can still be effected using authentication. This degree of secured pairing is not easy with simple client devices, i.e. client devices having sparse resources that cannot perform authentication using Digital Certificates.

Further, when a client device wishes to connect to a server device, it is of utmost importance that it connects to the device intended. If multiple devices are within reach of the client, the client device should have a way of showing how many server devices responded to its request.

In advanced client devices, the name and type for each responding server can be displayed.

The object of the present invention is therefore to establish safe pairing of wireless communicating medical devices.

It is another object of the present invention to provide for an indication to the client device in the event a single or multiple servers respond to a request by the client.

It is yet another object of the present invention to enable a client device to identify all the listening server devices and also authenticate the servers responding to the request by the client. Still another object of the present invention is to enable the client devices to choose one server device among the server devices responding.

### SUMMARY OF THE INVENTION

To achieve the said objects, the present invention provides a method and system for establishing a wireless connection by the client with an intended server.

In the following, a medical device is generally denoted a client as a wireless device type, correspondingly the server is a wireless device type as well.

In the present context, the term ‘medical device’ can mean an injector type device (such as a pen injector or a jet injector) for delivering a discrete dose of a liquid medication (possibly in the form of small drops), a medication pump for continuous delivery of a liquid medication, an inhaler, spray or the like for delivering a discrete or continuous dose of a medication in vaporized, ‘atomized’ or pulverized form, preferably the medication is insulin. The medical device can also mean a blood glucose tester or a BGM (blood glucose measurement device), e.g. a device using so-called test-strips for the manual measurement of the glucose level in the blood or a more advanced device, i.e. a CGM (continuous glucose measurement device) performing automatic continuous measurements of the blood glucose level.

U.S. Pat. No. 6,540,672, U.S. Pat. No. 6,656,114, US2002010432 and US2003032868 all disclose intelligent medical devices, which are hereby incorporated by reference in its entirety. U.S. Pat. No. 5,888,477 (which is hereby incorporated by reference in its entirety) discloses an inhaler with robust features that may be used for insulin delivery. U.S. Pat. No. 5,785,049 to Smith et al (which is hereby incorporated by reference in its entirety) discloses a device suitable for powdered medication delivery.

A client device discovers all the listening server devices when they respond to a query broadcast by the client. In case of multiple devices within the reach of the client, multiple servers may respond.

The first embodiment of the present invention discloses client devices having a display means that have the facility to look through the name and type of the responding servers.

A second embodiment of the present invention relates discloses client devices with an indicator (LED, buzzer etc) that may be used to indicate whether single or multiple servers responded.

In case of an LED, one can have a flashing if multiple servers responded or a steady light, if single server responded. In case of multiple servers, the client device can just move to any other place and try or, if possible, turn off the unintended server.

In all cases, the goal for the client is to end up choosing and subsequently connecting with one single server, i.e. the intended server. Hereby, the client is paired with this server.

In the following, a brief description of the accompanying drawings is disclosed:

### BRIEF DESCRIPTION OF THE DRAWINGS

FIG. 1 describes a schematic block diagram of a medical device using a Bluetooth protocol as disclosed by FIG. 2 of International publication number WO03/15838,

FIG. 2 illustrates a client device according to the first embodiment,

FIG. 3 illustrates a client device according to a second embodiment,

FIG. 4 describes a protocol for safe pairing of wireless medical devices,

FIG. 5 illustrates multiple servers responding on a single client request, and

FIG. 6 illustrates a flowchart for the wireless communication protocol.

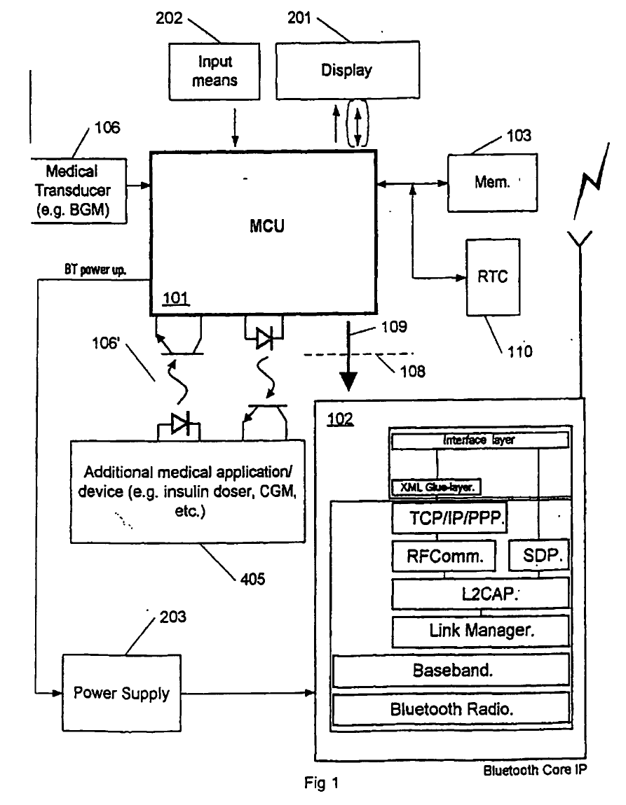

It will be understood by those skilled in the art that the foregoing general description and the following detailed description are exemplary and explanatory of the invention and are not intended to be restrictive thereof.

Through out the patent specification, a convention employed is that in the appended drawings, like numerals denote like components where appropriate.

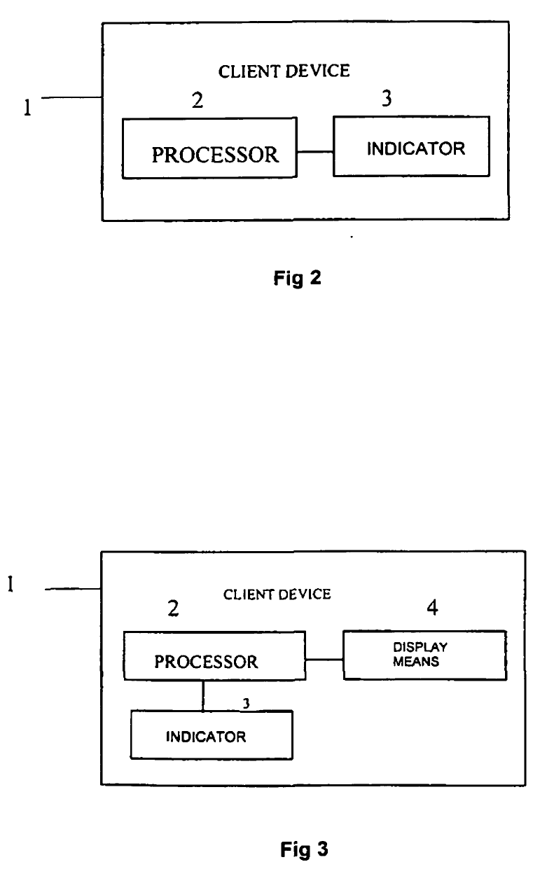

A simple client device, 1 as illustrated by FIG. 2 has an indicator, 3, along with a processor 2. The processor is responsible for processing the data stored with the device, establishing connections, sending requests etc. The indicator 3, can be a LED, a vibrator, a buzzer or a simple display, etc. The indications are different in case of a single server responding to the client, and multiple servers responding to the client, in the latter case more indications are presented.

In an embodiment of the present invention in case of an advanced client device as shown by FIG. 3, the device has a displaying means 4 along with an indicator 3. The indicator, 3, functions as in case of a simple client device, indicating whether a single server responded or multiple servers responded. The display device 4 is responsible for displaying the name and/or type of server(s) responding.

In another preferred embodiment the processor, 2 creates a priority list by assigning priority to each of the servers responding. The client device either chooses any one of the server names displayed or chooses the one with highest priority and establishes a connection.

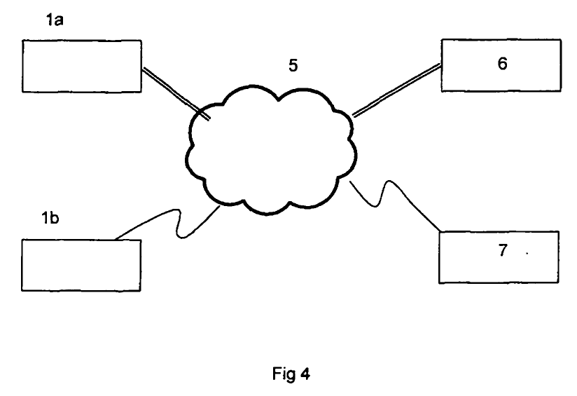

FIG. 4 describes that a client device 1a, that intends to establish a connection with a server device 6, will be paired with the correct device, e.g. a medical device through this protocol. Similarly, client device 1b, will be paired to the intended server device, 7. Wireless communication protocol ensures a safe and correct pairing of client and server devices. So in any case the client device 1a will not be paired with server device 6.

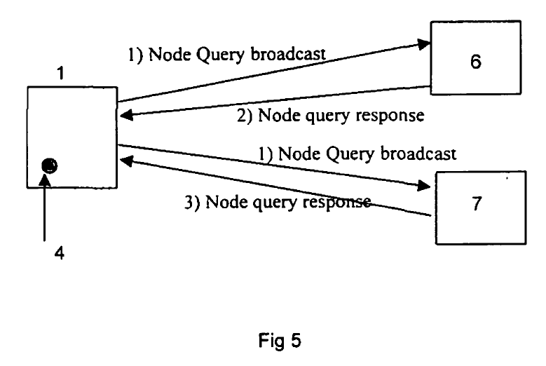

FIG. 5 shows how multiple servers can respond to a request by a client device. Here a simple client device, 1, having an indicator, an LED, 4), sends a node query broadcast 1. Servers 6 and 7 are in the range of the client and hence it can be possible that both of them respond to the client through the node query response. Server 6 responds through query response 2 and server 7 responds through query response 3. The indicator 4 gives a flash of light indicating that more than one server are responding.

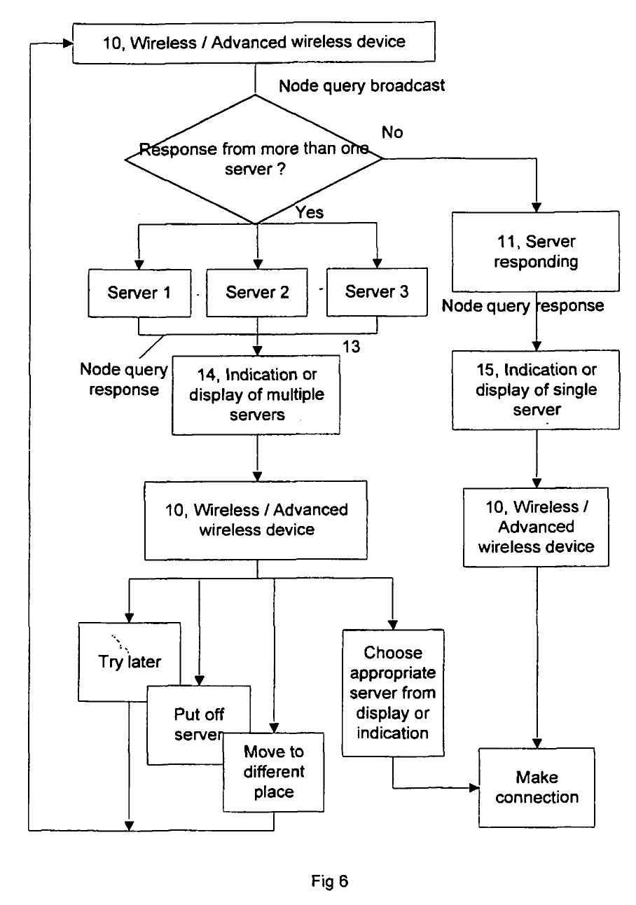

FIG. 6 is a flow diagram showing how the wireless communication protocol works. It starts with a simple or advanced wireless medical device (10) trying to establish a contact with a server and sends a node query broadcast. There can be two possibilities; the intended server responds with a node query response (11) or multiple servers simultaneously each sends a node query response (13). The node query response would contain information about device address, device type and/or more. In the first case, the indicator will give indications for a single server responding (15) and in the latter case, for multiple servers. In case of advanced wireless devices, the display means will display the names of multiple servers (14) or single server as the case may be. In case of single server, the wireless device (medical device) will just make connections with that single server, if not, the wireless device would either try again later or put off an unintended server if possible, or move to a different place to change its range. The wireless device cannot establish a connection until it has only one server responding to ensure safe pairing. An advanced device need not do any of these because such a wireless device can choose a server from those displayed by the display means and correspondingly and subsequently establish connection with that specific server. The wireless device will create a list of the entire server names displayed and if necessary assign priority to each one of them. Accordingly, the wireless device will attempt establishing connection starting with the highest priority server and only attempt establishing connection to the next lower prioritized server if connection fails with said highest priority server, etc.

According to the protocol of the present invention in case multiple servers respond to a node query broadcast, it is preferable that the server modules are given hierarchical priority and the potential server module with the highest priority among the activated and present potential server modules becomes the server actually paired with the wireless device.

The communication between the client-server or two wireless medical devices is established by communication means.

Said communication means is adapted to communicate information according to one or more of:
radio frequency (RF) communication
Infrared communication
HTTP (Hyper Text Transmission Protocol)
SHTTP (Secure Hyper Text Transmission Protocol)
TCP/IP Protocol (transmission Control Protocol/Internet protocol)
PPP (Point to Point
SSL (Secure Socket Layer)
TLS (Transport Layer Security)
IrDA

The communication means is preferably an infrared communication means, providing IR communication of data information between the client/server devices.

Alternatively, the communication means is an inductive means i.e. comprising inductive coils or the like in each apparatus.

Alternatively, the communication means is an electrical communications means i.e. a simple switch mechanism that may be used to transfer of data information between the devices.

Additionally, other types of communications may be used, such as RF communication e.g. Bluetooth or other type, etc.

In one embodiment, the communication means are adapted to communicate with a wireless access point/ a mobile terminal where the access point/ the terminal is adapted to communicate according to one or more of:
GSM (Global System for mobile communication)
GPRS (General packet Radio System)
UMTS (Universal Mobile telephone System)

In this way, a great level of mobility is assured for the client as well as being able to transmit relevant data information to the world of cellular phones.

The means for indicating may include one of more of the following: a display, a buzzer, a speaker, vibrator or a graphical user interface.

A timer or other external events can initiate the request for establishing an appropriate connection between at least two wireless devices.

It will readily be appreciated by those skilled in the art that the present invention is not limited to the specific embodiments shown herein. Thus variations may be made within the scope and spirit of the accompanying claims without sacrificing the principal advantages of the invention.

1. A method for safe pairing of wireless medical devices, said method characterized by
sending a node query broadcast by a first wireless medical device to nearby wireless medical devices;
listening to the node query responses sent, by the nearby wireless medical devices,
determining and indicating as to whether single or multiple Node Query responses are received by the first wireless medical device, and
choosing and establishing a connection with the appropriate wireless medical device.

2. A method according to claim 1 further comprising the step of prioritizing the node query responses and accordingly establishing connection with the nearby wireless medical device according to a priority.

3. A method according to claim 1, wherein the first wireless medical device has different indications for single and multiple node query responses received.

4. A method according to claim 1, wherein the connection is established by the said first wireless medical device if the indication is for a single response.

5. A method according to claim 1 wherein the first wireless medical device establishes connection with the nearby wireless medical devices including compatible or incompatible devices.

6. A method according to claim 1, further comprising the step of displaying by the first wireless medical device the names and types of the said nearby wireless medical devices sending the node query response.

7. A method according to claim 1 further comprising the step of adopting corrective measures by the first wireless medical device to resolve a situation in case multiple Node Query responses are received.

8. A method according to claim 7 wherein said corrective measures includes moving first wireless medical device to a different location or switch off a nearby unintended wireless medical device.

9. A system for safe pairing of wireless medical devices, characterized in that the said system comprises:
first wireless medical device including:
means for sending node query broadcast
means for listening to the node query responses,
means for determining and indicating whether a single or multiple node query response are received and,
means for choosing and means for establishing a connection with the appropriate wireless medical device.

10. A system according to claim 9 further comprising the means for prioritizing the node query responses and accordingly establishing connection with the nearby wireless medical device according to a priority.

11. A system according to claim 9, wherein the said first wireless medical device includes a indicating means.

12. A system according to claim 9, wherein the said means for determining and indicating include LED, buzzer, speaker, graphical user interface or a vibrator.

13. A computer program product comprising computer readable program code stored on computer readable storage medium embodied therein for providing a system for ensuring safe pairing of wireless communicating medical devices comprising:
computer readable program code means configured for sending node query broadcast,
computer readable program code means configured for receiving node query response,
computer readable program code means configured for determining and indicating whether single or multiple response received and,
computer readable program code means configured for establishing a connection only when single response is received.

14. A computer program product of claim 13 further comprising computer readable program code means configured for displaying the names and types of listening medical devices.

15. The computer program product according to claim 13 further comprising computer readable program code means configured for prioritizing the node query responses and accordingly choosing and establishing connection with the nearby wireless medical device according to a priority.
